(19) United States
(12) Patent Application Publication
(10) Pub. No.: US 2014/0190692 A1
(43) Pub. Date: Jul. 10, 2014

(54) PRODUCTION-TREATING CHEMICALS ADDED TO POLYMER SLURRIES USED IN TREATMENT OF OIL AND GAS WELLS

(71) Applicant: Independence Oilfield Chemicals, The Woodlands, TX (US)

(72) Inventors: Jeffrey C. Hibbeler, The Woodlands, TX (US); James M. Brown, Lago Vista, TX (US)

(21) Appl. No.: 13/913,611

(22) Filed: Jun. 10, 2013

Related U.S. Application Data
(60) Provisional application No. 61/748,985, filed on Jan. 4, 2013.

(51) Int. Cl. C09K 8/524; E21B 43/25; E21B 41/02; E21B 43/26; E21B 37/06

(52) U.S. Cl. CPC C09K 8/524; E21B 43/26; E21B 37/06; E21B 41/02; E21B 43/25
USPC 166/279; 507/90; 166/308.4

(57) ABSTRACT

Production-treating chemicals, such as paraffin inhibitors, corrosion inhibitors and scale inhibitors are provided along with water-soluble polymers in a base oil phase to be used in a well treatment. The mixture may be provided as a separate product or mixed at a well site when performing a well treatment, such as hydraulic fracturing, acidizing or gravel packing.

This non-provisional application claims priority to U.S. Provisional Application Ser. No. 61/748,985 filed on Jan. 4, 2013.

### BACKGROUND OF INVENTION

1. Field of the Invention

This invention relates to treatment of wells. More particularly, production-treating chemicals are added to a base oil having polymer dispersed therein that is then mixed with water to form a water-based gel containing the polymer and production-treating chemicals that may be used in hydraulic fracturing or other fluid injection processes in wells.

2. Description of Related Art

The fluid used in hydraulic fracturing of wells and other treatment processes is normally water or brine containing a soluble polymer to increase the viscosity of the water phase. The most commonly used polymer is guar gum, which is a natural polymer removed from the guar bean. Derivatized guar may be used. Other polymers used include cellulose derivatives and synthetic polymers such as polyacrylamide. The polymers are usually added to the water stream as it is pumped down a well at a concentration in the range from about 10 to about 50 pounds per thousand gallons of water. Other well treatments, such as gravel packing and acidizing, may also employ water containing water-soluble polymers.

The first step in mixing a polymer into water is to “hydrate” the polymer. This step is made more difficult by the fact that balls or “fish eyes” of the polymer tend to form if dry polymer is added to water, preventing complete dispersal and solution of the polymer to form the “gel” fluid. Methods of improving the dispersion of the polymer have included surface treatment of the polymer to delay its hydration and addition of surfactants to the water. U.S. Pat. No. 4,828,034 discloses adding the polymer first to a base oil and mixing to form a dispersion in oil, then discharging the mixture into a water stream. U.S. Pat. No. 7,104,328 discloses apparatus particularly suited for carrying out the process using a base oil. Other methods for mixing a water-soluble polymer into water without using a base oil to form fracturing fluids in a continuous mixing process have been used.

Production-treating chemicals are often injected into wells to improve conditions in a well or to increase production rate from a well. Examples of such chemicals are: paraffin inhibitors, corrosion inhibitors and scale inhibitors. Each chemical is adapted for maximum effectiveness in the well being treated. One method of placing such chemicals in a well is disclosed in U.S. Pat. No. 7,493,955, which is hereby incorporated by reference herein for all purposes. The method disclosed includes adsorbing the production-treating chemicals onto a water-insoluble adsorbent having a high surface area. The advantage of using the adsorbent is that the adsorbed chemicals are produced back from the well for an extended period of time, thus having a longer-term effect on the well. The patent claims pumping solid adsorbent particles into a formation in a fracturing or acidizing fluid or introducing the particles into a wellbore in any fluid. The limitation of this technique, other than increased cost, is that such particles may have a deleterious effect on the flow capacity of the well.

What is needed is an effective, low-cost method for introducing production-treating chemicals into a well. Preferably, the method will allow the treating chemicals to be produced at low concentrations in the fluids coming from a well for an extended period of time after the treating chemicals are injected into a well.

### BRIEF SUMMARY OF THE INVENTION

In a prior art method, water-soluble polymer is added to an oil phase and the oil phase is mixed with water to form a water-based gel used in hydraulic fracturing. In the method disclosed herein, one or more production-treating chemicals are also added to the oil phase, along with the water-soluble polymer. The treating chemical may partially partition into the water phase or remain in the oil phase, which is normally in the form of oil droplets. The oil droplets serve as a reservoir for the production-treating chemical, which may then be adsorbed on the walls of the hydraulic fracture or enter the interstices of the rock around the fracture. Water soluble production-treating chemicals may be absorbed onto clay or polymer that is then dispersed in the oil. A chemical placement method that allows deep penetration of the chemicals into a reservoir around a well, allows adsorption on a larger area of rock and a longer-lasting treatment is provided. For environmental reasons, mineral oil having low aromatic hydrocarbon content is preferred for use in the process.

### BRIEF DESCRIPTION OF THE SEVERAL VIEWS OF THE DRAWING(S)

FIG. 1 is a diagram of apparatus for mixing the materials used in the method disclosed.

### DETAILED DESCRIPTION OF THE INVENTION

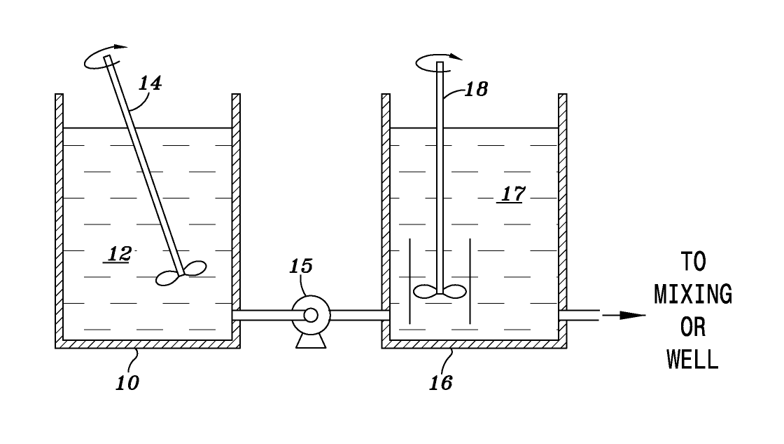

Referring to FIG. 1, tank 10 is designed to mix materials in oil base fluid 12, using mixer 14. The oil is preferably low in aromatics, such as a paraffinic mineral oil. Water-soluble polymer may be slurried with the oil to form a dispersion of individual polymer particles. The concentration of polymer in the slurry may be in the range from about 2 to 10 pounds of polymer per gallon of slurry. Such a process is described in, for example, U.S. Pat. No. 4,828,034, which is hereby incorporated by reference for all purposes. Treating chemicals may be added in tank 10, according to the method disclosed herein. Surfactants or co-solvents may be incorporated into the oil phase to improve solubility or dispersability of treating chemicals. Pump 15 transfers the slurry containing treating chemicals to tank 16 and provides additional mixing of the slurry. Liquid 17 in tank 16 is water- or brine-based. Mixing is provided by mixer 18 as hydration of the water-soluble polymer occurs. Additional mixing tanks may be provided (not shown) to allow additional time for hydration of the polymer. Polymer transfers from the oil phase into the water phase in tank 16. Treating chemical may be partially transferred to the water phase or may remain in the oil phase, which will usually be in the form of oil droplets formed by the mixing process. Surfactants, well known in the art, may be added to the oil phase to facilitate emulsification of the oil phase into the water phase. Alternatively, mixing of chemicals illustrated as occurring in tank 10 may occur in a remote location and the mixture may be transported to a well and added to the liquid in tank 16.

The treating chemical or chemicals to be added to oil phase 12 are selected based on conditions in the well to be treated. Examples of treating chemicals are those capable of addressing the undesired effects caused by scale formations, salt formations, paraffin deposition, emulsification (both water-in-oil and oil-in-water), gas hydrate formation, corrosion, asphaltene precipitation and paraffin formation. Further, other suitable treatment agents include foaming agents, oxygen scavengers, biocides and surfactants as well as other agents wherein slow release into a production well is desired.

Commercial products marketed for each application may be used, or such products may be modified to affect solubility in the oil phase or water phase. Such modifications, such as addition of oleophilic groups to increase oil solubility, or addition of polar groups to increase water solubility, are well known in the art. For injection into a well producing oil, additional water solubility of treating chemicals, providing greater amount of treating chemical in the water phase, may be used to provide slower return of the treating chemical in produced fluid from the well. Treating chemicals may also be selected to increase adsorption of the chemical on the surface of rock contacted by the treating fluid. This increased adsorption will also provide slower return of the treating chemical in produced fluid from the well.

For example, if the treating chemical is to be used to inhibit scale formation in a well, a suitable chemical would be an oil-soluble dispersion of amino tris(methylene phosphonic acid). This material is commercially available as BS-156 from Syrgis Performance Chemicals of Houston, Tex. This material may be added to oil phase 12 of FIG. 1 during mixing of a fluid to be pumped into a well. This material may be modified to change solubility in oil and water phases for application in specific wells. Other materials that may be used for scale inhibition include organic phosphonates, aminophosphonates, phosphonates derived from alkyloxylated amines, polymers, and multi-polymers of acrylic acid, methacrylic acid, acrylamidomethylpropanesulfonic acid (AMPS), n-tert-butylacrylamide (NBA), hydroxypropylacrylate, phosphinoacrylate, sulfonate styrene, ethylacrylate, maleic anhydride, phosphate esters, carboxymethylinulin, polyepoxysuccinic acid, polyaspartic acid and mixtures of the same.

Treating chemicals to be used to inhibit paraffin deposition or disperse paraffin or asphaltene include, but are not limited to: polymers and copolymers of olefin/maleic esters, olefin/imides, ethylene vinyl acetates, alkyl phenol resins, alkyl esters of acrylic acid, alkyl esters of methacrylic acid, vinyl pyridine, alkyl substituted phenol-formaldehyde resins, polyisobutylene succinic anhydride and sorbitan monoleate.

Treating chemicals to be used to inhibit corrosion include mixtures containing one or more of a group selected from fatty imidazolines and salts with alkyl amines and alcoholamines; fatty amido imidazolines, dimer and trimer acids derived from tall oil fatty acid (TOFA); quaternary amine compounds including alkyl pyridine benzyl quaternary amines; cocodimethyl benzyl quaternary amines; phosphate esters of triethanol amine; acetylenic alcohols such as propargyl alcohol, butynol; cinnamaldehye; and alkyl imidoamide of TOFA.

Treating chemicals to be used to inhibit gas hydrate formation include mixtures of polyoxypropylenediamine and other Jeffamines available from Huntsman Corporation and triethylene glycol amine.

Demulsifiers may include polyols and polyol esters; alkyloxylated resins of; phenol formaldehyde; resins of diepoxides; resins of alkylaryl sulfonic acids; resins of nonyl phenol; amyl resins and butyl resins.

Hydrogen sulfide scavengers such as trihydroxyethyltriazine and trihydroxymethyltriazine. metal borate complexes, bisoxazolidines and reaction products of alkylenepolyamine with fomaldehyde may be added.

Salt Inhibitors such as carboxymethylinulin, sodium ferrocyanide and nitriloacetic acid derivatives may be added.

Defoamers such as polyalkylsiloxanes and silicone oils may be added.

Biocides such as quaternary alkyl amine compounds, glutaraldehyde, tetrakishydroxymethylphosphonium sulfate, isothiazoline, dibromonitrilopropionamide, alkylthiocarbamates, tributyltetradecylphosphonium chloride, tetrahydro-3,5,dimethyl-2H-1,3,5-thiadiazine-2-thione and mixtures of the above may be added.

Oxygen scavengers such as erythorbates, hydroquinone, methyhydroquinone, sulfite salts, carbohydrazide, hydrazine, methylethylketoxime and diethylhydroxylamine with and without metal activators may be added.

Slurries of water-soluble polymer in oil may be sold and transported as a product for use by a pumping service company in well treatments. Such products may be modified, according to this disclosure, by the addition of well treatment chemicals such as paraffin inhibitors, corrosion inhibitors and scale inhibitors or other chemicals disclosed herein. This product can allow the pumping service company to provide a treatment for an operator that is specifically adapted for the well treated.

Although the present invention has been described with respect to specific details, it is not intended that such details should be regarded as limitations on the scope of the invention, except to the extent that they are included in the accompanying claims.

I claim:

1. A method for treating a well with a production-treating chemical, comprising:
adding the treating chemical to an oil phase along with a water-soluble polymer and forming a slurry of the water-soluble polymer in the oil phase;
mixing the oil phase with a water phase to allow the water-soluble polymer to transfer to the water phase and form a gel in the water phase; and
pumping the water phase and the oil phase into the well.

2. The method of claim 1 wherein the production-treating chemical is selected from the group consisting of those capable of addressing the effects caused by scale formation, solid salt formation, paraffin deposition, emulsification, gas hydrate formation, corrosion, asphaltene precipitation, foam, oxygen, hydrogen sulfide and bacteria.

3. The method of claim 1 wherein the production-treating chemical is selected from the group consisting of an oil-soluble dispersion of amino tris(methylene phosphonic acid), organic phosphonates, aminophosphonates, phosphonates derived from alkyloxylated amines, polymers and multi-polymers of acrylic acid, methacrylic acid, acrylamidomethylpropanesulfonic acid (AMPS), n-tert-butylacrylamide (NBA), hydroxypropylacrylate, phosphinoacrylate, sulfonate styrene, ethylacrylate, maleic anhydride, phosphate esters, carboxymethylinulin, polyepoxysuccinic acid, polyaspartic acid and mixtures of the same, polymers and copolymers of olefin/maleic esters, olefin/imides, ethylene vinyl acetates, alkyl phenol resins, alkyl esters of acrylic acid, alkyl esters of methacrylic acid, vinyl pyridine, alkyl substituted phenol-formaldehyde resins, polyisobutylene succinic anhydride and sorbitan monoleate, mixtures containing one or more of a group selected from fatty imidazolines and salts with alkyl amines and alcoholamines, fatty amido imidazolines, dimer and trimer acids derived from tall oil fatty acid (TOFA), quaternary amine compounds such as alkyl pyridine benzyl quaternary amines, cocodimethyl benzyl quaternary amines, phosphate esters of triethanol amine, acetylenic alcohols such as propargyl alcohol, butynol; cinnamaldehye, alkyl imidoamide of TOFA, mixtures of polyoxypropylenediamine and other Jeffamines available from Huntsman Corporation, triethylene glycol amine, polyols and polyol esters; alkyloxylated resins of phenol formaldehyde, resins of diepoxides, resins of alkylaryl sulfonic acids, resins of nonyl phenol, amyl resins and butyl resins, trihydroxyethyltriazine and trihydroxymethyltriazine. metal borate complexes, bisoxazolidines and reaction products of alkylenepolyamine with fomaldehyde, carboxymethylinulin, sodium ferrocyanide and nitriloacetic acid derivatives, polyalkylsiloxanes and silicone oils, quaternary alkyl amine compounds, glutaraldehyde, tetrakishydroxymethylphosphonium sulfate, isothiazoline, dibromonitrilopropionamide, alkylthiocarbamates, tributyltetradecylphosphonium chloride, tetrahydro-3,5,dimethyl-2H-1,3,5-thiadiazine-2-thione, erythorbates, hydroquinone, methyhydroquinone, sulfite salts, carbohydrazide, hydrazine, methylethylketoxime and diethylhydroxylamine with and without metal activators.

4. The method of claim 1 wherein the water phase is pumped under conditions to form a hydraulic fracture around the well.

5. The method of claim 1 wherein the oil phase is a paraffinic oil.

6. The method of claim 1 wherein the water-soluble polymer is selected from the group of polymers consisting of guar or guar derivatives, cellulose derivatives and polyacrylamides.

7. The method of claim 1 wherein the production-treating chemical is water-soluble and is added to the oil phase as an adsorbent on clay or polymer.

8. A chemical mixture for use in a well treatment, comprising:
an oil base;
a water-soluble polymer dispersed in the oil base; and
a production-treating chemical dispersed or dissolved in the oil base.

9. The mixture of claim 8 wherein the production-treating chemical is selected from the group consisting of those capable of addressing the undesired effects caused by scale formation, solid salt formation, paraffin deposition, emulsification, gas hydrate formation, corrosion, asphaltene precipitation, foam, oxygen, hydrogen sulfide and bacteria.

10. The mixture of claim 8 wherein the water-soluble polymer is selected from the group of polymers consisting of guar or guar derivatives, cellulose derivatives and polyacrylamides.

11. The mixture of claim 8 wherein the oil phase is a paraffinic oil.

12. The mixture of claim 8 wherein the production-treating chemical is water-soluble and is added to the oil phase as an adsorbent on clay or polymer.

13. A method for treating a well, comprising:
providing the chemical mixture of claim 8;
mixing the chemical mixture with a water phase at the well; and
pumping the water phase into a well to hydraulically fracture, acidize or gravel pack the well.
